(19) United States
(12) Patent Application Publication
(10) Pub. No.: US 2004/0246063 A1
(43) Pub. Date: Dec. 9, 2004

(54) Nonreciprocal circuit element

(75) Inventors: Takamitsu Shibayama, Fukushima-ken (JP); Hitoshi Onishi, Niigata-ken (JP)

Correspondence Address: Brinks Hofer Gilson& Lione, P.O. Box 10395, Chicago, IL, 60610, US

(73) Assignee: Alps Electric Co., Ltd.

(21) Appl. No.: 10/843,243

(22) Filed: May 10, 2004

(30) Foreign Application Priority Data
May 12, 2003 (JP) 2003-133292

(51) Int. Cl. H01P 1/36

(52) U.S. Cl. 333/24.2; 333/1.1

(57) ABSTRACT

A nonreciprocal circuit element includes a yoke body; a magnetic substrate; a plurality of line conductors; a plurality of capacitance elements; and a magnet member. The plurality of line conductors overlap each other on the main surface of the magnetic substrate in such a manner as to be insulated from each other and are connected to each other on the other surface of the magnetic substrate. The end portions of the line conductors which are made to overlap on the main surface of the magnetic substrate are connected correspondingly to the capacitance elements, a termination resistor is connected to one of the line conductors, and the width of the line conductor to which the termination resistor is connected is smaller than the individual widths of a plurality of the other line conductors.

### BACKGROUND OF THE INVENTION

1. Field of the Invention

The present invention relates to nonreciprocal circuit elements, such as isolators, which have been used in high-frequency bands, such as the microwave band, and for which a smaller size and a lighter weight thereof have been in development.

2. Description of the Related Art

In communication devices, there have been demands for a smaller, lower loss, and higher performance devices. There have also been similar demands for high-frequency magnetic parts, such as isolators, used in such communication devices.

In isolators used as nonreciprocal circuit elements, whose size conventionally is approximately a 7-mm square, smaller isolators have gradually been developed, such as a 5-mm square, a 4-mm square, a 3.5-mm square, and a 3.0-mm square. There have also been demands for those smaller isolators to have higher performance.

FIG. 11 is an exploded, perspective view showing a conventional ordinary nonreciprocal circuit element. An isolator shown in FIG. 11 is formed in such a way that a circular-plate-shaped magnet 103 for applying a bias, a magnetic assembly 105, capacitor substrates 106, 107, and 108, a termination resistor 109, and a frame-shaped case body 110 are disposed between a lower yoke 101 and an upper yoke 102.

The magnetic assembly 105 of this example includes a magnetic substrate 112 made of a ferrite circular-plate, line conductors 113, 114, and 115, which are arranged in such a manner as to surround the obverse surface thereof, and a plate-shaped common electrode (not shown) by which these conductors are connected on the reverse surface of the magnetic substrate 112.

Capacitor substrates 116, 117, and 118 in the shape of a thin plate are arranged around the inner rim of the case body 110. The magnetic assembly 105 is arranged inside the capacitor substrates 116, 117, and 118. The front-end sections 113a, 114a, and 115a of the respective line conductors 113, 114, and 115 of the magnetic assembly 105 are soldered and bonded to capacitor substrates 106, 107, and 108 positioned below them, respectively.

Furthermore, the circular-plate-shaped magnet 103 is arranged above them, and the case body 110 is formed integrally as a box shape by sandwiching the case body 110 from above and below by the lower yoke 101 and the upper yoke 102, thereby forming a thin nonreciprocal circuit element 100.

One approach for reducing the size of the entire nonreciprocal circuit element 100 of the configuration shown in FIG. 11 is to reduce the size of the magnetic substrate 112 of the magnetic assembly 105. When the size reduction of the magnetic substrate 112 is taken into consideration, if the magnetic substrate 112 is in the shape of a circular plate, the area efficiency is poor. Inevitably, a magnetic substrate in the shape of a rectangle is formed, and the capacitor substrates 116 to 118 in the shape of a thin plate are arranged side by side around the surrounding thereof, thereby reducing the wasted space so as to achieve a smaller size. However, when the magnetic substrate 112 is formed rectangular, in order that the capacitor substrates 106 and 107 are arranged on one of the sides thereof, and the capacitor substrate 108 and the termination resistor 109 are arranged on the other side thereof, the magnetic substrate 112 inevitably becomes shaped as a horizontally extending rectangle in terms of a layout with high area efficiency.

In a case where a horizontally extending rectangular magnetic substrate is formed, of the line conductors 113, 114, and 115 which are wound around it, the length of the line conductor 115, which is wound in a direction intersecting the longitudinal direction, inevitably becomes shorter than the length of the line conductors 113 and 114, which are wound along the longitudinal direction, and the inductance of the line conductors 113 and 114 becomes larger than the inductance of the line conductor 115.

In the nonreciprocal circuit element 100, since the numerical value of the isolator is determined by the capacitance of the capacitor provided and the resistance value, and it is used by being made to resonate in a high-frequency band, the inductance value and the capacitance value affect the characteristics. Therefore, the frequencies used in the line conductors 113 to 115 are desired to be the same. Consequently, when the inductance of the line conductors 113 and 114 is larger than the inductance of the line conductor 115 in the manner described above, the capacitance of the capacitor substrate 108 needs to be larger than the capacitance of the capacitor substrates 106 and 107, presenting a problem in that, if the capacitor substrate 108 is enlarged, size reduction of the nonreciprocal circuit element 100 is hindered.

Furthermore, in the above-described nonreciprocal circuit element, when the value of the inductance of the line conductor 115 connected to the resistor 109 is considered, it is considered to be more advantageous that the conductor itself of the line conductor 115 be made thicker than those of the other line conductors 113 and 114. In addition, in this type of nonreciprocal circuit element, considering the achievement of the improvement of impedance matching or reflection characteristics, a configuration (U.S. Pat. No. 6,642,831) in which the width of a line conductor connected to a resistor is larger than the width of the other line conductors is known, and it is common practice that the width of a line conductor connected to a resistor is larger than the width of the other line conductors.

Furthermore, in order to improve isolation, a configuration in which a line conductor connected to a resistor is provided with a slit, and the conductor having two divided portions is folded on the magnetic substrate 112 (see U.S. Pat. No. 6,642,831) is known. However, when the conductor having divided portions is formed, a problem arises in that the capacitor substrate needs to be enlarged for frequency matching.

However, while the inventors of the present invention were making research in order to reduce the size of the nonreciprocal circuit element, when research was continued with a horizontally extending rectangular magnetic substrate by proceeding with a nonreciprocal circuit element whose size is reduced by more than a certain degree, for example, reduced to the size of a square of 4 mm or less, even if the line conductor connected to the resistor is not made thick, it was found that the capacitance connected to the line conductor can be reduced in size in an area where there are no problems in terms of isolation characteristics, and thus, the inventors of the present invention arrived at the present invention.

### SUMMARY OF THE INVENTION

The present invention has been made in view of the above circumstances. An object of the present invention is to provide a nonreciprocal circuit element in which, even if a line conductor connected to a resistor is made shorter and narrower than the other line conductors, no problem is occurs in terms of characteristics of the nonreciprocal circuit element, thus eliminating degradation of the isolation characteristics and reducing the size.

To achieve the above-mentioned object, in one aspect, the present invention provides a nonreciprocal circuit element including: a yoke body; a magnetic substrate; a plurality of line conductors arranged on the main surface of the magnetic substrate; a plurality of capacitance elements arranged around the magnetic substrate; and a magnet member for applying a bias magnetic field to the magnetic substrate, wherein the plurality of line conductors overlap each other on the main surface of the magnetic substrate in such a manner as to be insulated from each other and are connected to each other on the other surface of the magnetic substrate, the end portions of the line conductors which are made to overlap on the main surface of the magnetic substrate are connected correspondingly to the capacitance elements, a termination resistor is connected to one of the line conductors, and the width of the line conductor to which the termination resistor is connected is smaller than the individual widths of a plurality of the other line conductors.

By making the width of the line conductor connected to the termination resistor narrower than that of the other line conductors, the size of the capacitance element connected to the line conductor connected to the termination resistor can be reduced, thus contributing to the size reduction of the entire nonreciprocal circuit element.

In another aspect, the present invention provides a nonreciprocal circuit element including: a yoke body; a magnetic substrate; a plurality of line conductors arranged on the main surface of the magnetic substrate; a plurality of capacitance elements arranged around the magnetic substrate; and a magnet member for applying a bias magnetic field to the magnetic substrate, wherein the plurality of line conductors are made to overlap on the main surface of the magnetic substrate and are connected to each other on the other surface of the magnetic substrate, the end portions of the line conductors, which are made to overlap on the main surface of the magnetic substrate, are connected correspondingly to the capacitance elements, a termination resistor is connected to one of the line conductors, and at least a portion of the part positioned on the magnetic substrate is formed as one conductor in the line conductor to which the termination resistor is connected.

As a result of forming, as one conductor, the line conductor connected to the termination resistor in a state in which the size of the nonreciprocal circuit element is reduced, when compared to the configuration in which a conductor having two divided portions is formed by providing a slit, a range in which a desirable inductance can be selected with isolation being ensured exists, and the size of the capacitance element connected to the line conductor connected to the termination resistor can be reduced while ensuring desirable isolation, thus contributing to the size reduction of the nonreciprocal circuit element.

In the present invention, the line conductor to which the termination resistor is connected is formed as one conductor, and the other line conductors are formed as conductors having divided portions in which a slit is formed along the longitudinal direction thereof.

Isolation is improved by forming the line conductor as a conductor having divided portions by providing a slit in the line conductor, and the size of the capacitance element connected to the line conductor connected to the termination resistor can be reduced, thus contributing to the size reduction of the overall structure as a result of the size reduction of the capacitance element.

In the present invention, among the plurality of line conductors arranged on the magnetic substrate, the length of the portion on the magnetic substrate, of the line conductor which is formed as the one conductor, is shorter than the lengths of the other line conductors on the magnetic substrate.

The matching capacitance of the capacitance element connected to the line conductor connected to the termination resistor is larger than the capacitance connected to the other line conductors

The length of the portion where the line conductor connected to the termination resistor crosses the main surface of the magnetic substrate is longer by 5% or more than the straight-line width of the magnetic substrate along the direction of that portion.

By increasing the length of the line conductor connected to the termination resistor, the inductance of the line conductor can be increased, and the capacitance value of the capacitance element connected to the line conductor can be decreased correspondingly, thus contributing to the size reduction of the capacitance element.

In the present invention, excluding one line conductor connected to the termination resistor, a line conductor on the input side and a line conductor on the output side are provided, and a line segment connecting the grounding side and the termination resistor side of the magnetic substrate in the line conductor connected to the termination resistor is inclined in the range of 90° to 120° with respect to the line segment connecting the input side and the output side of the other line conductors excluding the line conductor.

The line conductor can be lengthened even a little by inclining the line conductor with respect to the magnetic substrate, the inductance of the line conductor can be increased, and the capacitance value of the capacitance element connected to the line conductor can be decreased correspondingly, thus contributing to the size reduction of the capacitance element.

### BRIEF DESCRIPTION OF THE DRAWINGS

FIG. 1A is a plan view showing the internal configuration of a nonreciprocal circuit element according to a first embodiment of the present invention;

FIG. 1B is a partial sectional view of the nonreciprocal circuit element;

FIG. 2 is a plan view showing an example of a magnetic substrate used in the nonreciprocal circuit element according to the present invention;

FIG. 3 is a development view of an electrode section used in the nonreciprocal circuit element according to the present invention;

FIG. 4A is a view showing an example of an electrical circuit of a mobile phone provided with this type of nonreciprocal circuit element;

FIG. 4B shows the operating principles of the nonreciprocal circuit element;

FIG. 5 is a plan view showing the internal configuration of a nonreciprocal circuit element according to a second embodiment of the present invention;

FIG. 6 is a plan view showing the internal configuration of a nonreciprocal circuit element according to a third embodiment of the present invention;

FIG. 7 is a plan view showing the internal configuration of a nonreciprocal circuit element according to a fourth embodiment of the present invention;

FIG. 8 shows the dependence of insertion loss (S₂₁) on frequency in the nonreciprocal circuit element of the embodiment;

FIG. 9 shows the dependence of isolation on frequency in the nonreciprocal circuit element of the embodiment;

FIG. 10 collectively shows the results of measurements of insertion loss (Loss) and isolation (Isol) in the nonreciprocal circuit element of the embodiment; and

FIG. 11 is an exploded perspective view showing an example of a conventional nonreciprocal circuit element.

### DESCRIPTION OF THE PREFERRED EMBODIMENTS

Embodiments of the present invention will now be described below with reference to the drawings. The present invention, however, is not limited to the following embodiments.

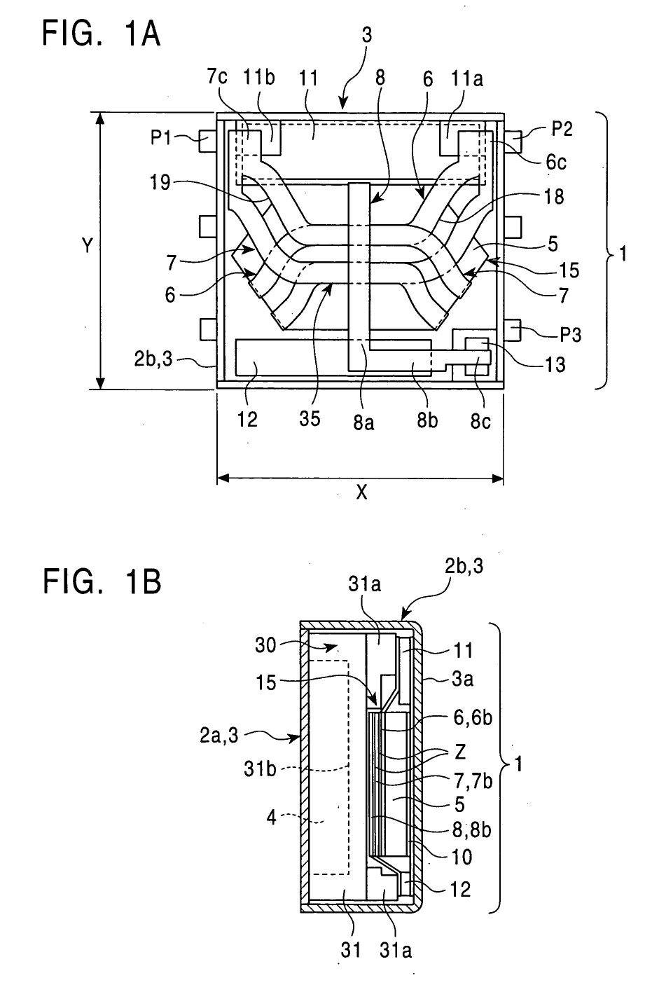

FIGS. 1 to 3 show a first embodiment of a nonreciprocal circuit element according to the present invention.

A nonreciprocal circuit element 1 of this embodiment is formed in such a way that, inside a hollow yoke body 3 formed of an upper yoke 2a and a lower yoke 2b, a magnet member 4 formed of a permanent magnet, a magnetic substrate 5, line conductors 6, 7, and 8, a common electrode 10 through which the line conductors 6, 7, and 8 are connected, capacitor substrates (capacitance elements) 11 and 12 arranged around the magnetic substrate 5, and a termination resistor (resistance element) 13 are provided.

The upper yoke 2a and the lower yoke 2b are made of a ferromagnetic material such as soft iron, and these are combined to form the hollow yoke body 3 in the shape of a thin box. It is preferable that an Ag-plated conductive layer be formed so as to be coated on the obverse and reverse surfaces of the upper yoke 2a and the lower yoke 2b. In this embodiment, the upper yoke 2a shaped like the letter U in side view is formed at a size which can be fitted into the lower yoke 2b shaped like the letter U in side view, so that a box-shaped magnetic closed circuit can be formed by combining the upper yoke 2a and the lower yoke 2b by fitting the respective openings thereof. The shape of the yokes 2a and 2b is not limited to the shape of the letter U as in this embodiment. Preferably, a plurality of yokes form a box-shaped closed magnetic circuit, and the shape of the yokes 2a and 2b may be any shape.

Regarding the outer dimensions of the hollow yoke body 3, preferably, the dimensions of at least two sides are each 4 mm or less, for example, a square of approximately 3.5 mm, or a square of approximately 3 mm. That is, as shown in FIG. 1A, when the nonreciprocal circuit element 1 is seen in plan view, preferably, the horizontal dimension X and the vertical dimension Y are each 4 mm or less, that is, a square of approximately 4 mm or less, for example, a square of approximately 3.5 mm. Such a small nonreciprocal circuit element can be suitably used in a small light-weight mobile communication device such as a mobile phone.

In the space surrounded by the lower yoke 2b and the upper yoke 2a, which are fitted together in the manner described above, in other words, inside the hollow yoke body 3, a magnetic assembly 15 formed of the magnetic substrate 5, the three line conductors 6, 7, and 8, and the common electrode 10 by which the line conductors 6, 7, and 8 are connected is housed.

The magnetic substrate 5 is made of a ferromagnetic material such as ferrite, and can be formed in various shapes, such as a circle or a square, as required. In this embodiment, as shown in FIG. 2, the magnetic substrate 5 is formed in the shape of a nearly hexagonal plate which is horizontally extended in plan view. More specifically, the magnetic substrate 5 is formed in the shape of a hexagonal plate which is horizontally extended in plan view, which is formed of two horizontally extended sides 5a and 5a, which oppose each other, and four oblique-side sections 5d through which the end portions of the long sides 5a and 5a are connected.

As shown in the development view of FIG. 3, the three line conductors 6, 7, and 8 and the common electrode 10 are formed integrally, and an electrode section 16 is formed mainly of the three line conductors 6, 7, and 8 and the common electrode 10. This common electrode 10 is formed of a main-unit section 10A made of a metal plate in a shape which is almost the same as that of the magnetic substrate 5. That is, the main-unit section 10A is formed in the shape of a nearly hexagonal plate in plan view, which is formed of two long-side sections 10a, which oppose each other, and four oblique-side sections 10d which are connected in an inclined manner to the end portions of the long-side sections 10a.

Then, a first line conductor 6 and a second line conductor 7 are formed so as to extend from the oblique-side sections 10d on one side of the common electrode 10. First, the first line conductor 6 formed of a first base conductor 6a, a first center conductor 6b, and a first front-end conductor 6c is formed so as to extend from the oblique-side section 10d on one side of the long-side section 10a on one side of the common electrode 10, and the second line conductor 7 formed of a second base conductor 7a, a second center conductor 7b, and a second front-end conductor 7c is formed so as to extend from the oblique-side sections 10d on the other end side of the long-side section 10a on the one side. Furthermore, the first line conductor 6 is formed as a line conductor on the input side of the nonreciprocal circuit element, and the second line conductor 7 is formed as a line conductor on the output side of the nonreciprocal circuit element.

The first line conductor 6 and the second line conductor 7 are formed in a wave shape or in a zigzag shape in plan view. With this construction, by increasing the inductance as much as possible by lengthening the conductor length of the line conductors 6 and 7, both a lower frequency and a smaller size of the nonreciprocal circuit element can be achieved. Furthermore, by increasing the inductance of the line conductors 6 and 7, the capacitance value of the capacitor elements 11 and 12 connected respectively to the line conductors 6 and 7 can be decreased comparatively, thus contributing to the size reduction of the nonreciprocal circuit element.

Next, in the central portion of the first line conductor 6 along the width direction thereof, a slit section 18 which reaches the base end portion of the front-end conductor 6c from the outer rim portion of the common electrode 10 is formed. As a result of the slit section 18 being formed, the line conductor 6 is divided into two divided conductors 6A and 6B. Also, in the central portion of the second line conductor 7 along the width direction thereof, a slit section 19 is formed in a similar manner, and the second line conductor 7 is divided into two divided conductors 7A and 7B by the slit section 19.

On the other hand, in the central portion on the other long-side section 10a side of the common electrode 10, the third line conductor 8 is formed so as to extend. The third line conductor 8 consists of a third base conductor 8a, which is protrusively formed from the common electrode 10, a third center conductor 8b, and a third front-end conductor 8c. The third base conductor 8a is formed so as to extend nearly at right angles from the common electrode 10, and the thickness (width) thereof is formed smaller than the individual thickness (width) of the first line conductor 6 and the second line conductor 7. The individual thickness (width) described herein of the first line conductor 6 and the second line conductor 7 is the total value of the widths of the conductors, including the portions of the slit sections 18 and 19, in other words, the total value of the widths of the divided conductors 6A and 6B and the slit section 18, or the total value of the widths of the divided conductors 7A and 7B and the slit section 19. When the inductance is set to be large, it is assumed that the width of the divided conductors or the substantial line width excluding the slit is set to be small.

The third center conductor 8b and the third front-end conductor 8c of the third line conductor 8 are formed so as to extend nearly at right angles to the third base conductor 8a.

In the electrode section 16 configured as described above, the main-unit section 10A thereof is provided along the reverse surface (one surface) of the plate-shaped magnetic substrate 5. The first line conductor 6, the second line conductor 7, and the third line conductor 8 are placed by being layered on the plate-shaped magnetic substrate 5 in such a manner that the first line conductor 6, the second line conductor 7, and the third line conductor 8 are folded on the obverse surface (the other surface) of the plate-shaped magnetic substrate 5 in this sequence. The electrode section 16, together with the magnetic substrate 5, constitutes the magnetic assembly 15. FIG. 1A shows a state in which the line conductors 6, 7, and 8 are layered in an overlapping manner.

Furthermore, as shown in FIG. 1B, preferably, the second line conductor 7 (the line conductor on the output side) is made to overlap the first line conductor 6 via an insulating sheet Z. Similarly, the third line conductor 8 is preferably made to overlap the second line conductor 7 via another insulating sheet Z. In this manner, the line conductors 6, 7, and 8 can be electrically insulated from one another.

Furthermore, by making the second line conductor 7 overlap the first line conductor 6, the inductance of the second line conductor 7 can be increased by bringing the second line conductor 7 closer to the plate-shaped magnetic substrate 5, and this is more advantageous for the size reduction of the nonreciprocal circuit element 1. Furthermore, by reducing variations in the inductance, variations in the output impedance can also be suppressed.

Furthermore, as shown in FIG. 1A, the length of the overlapping portion of the center conductor 6b and the center conductor 7b at the intersection portion 35 thereof is 10% or more of the horizontal length of portions where the line conductors 6 and 7 overlap the obverse surface (the other surface) of the plate-shaped magnetic substrate 5, and more preferably, it is 20% or more. In FIG. 1A, a case is shown in which the length of the portion where the two center conductors overlap at the intersection portion 35 is approximately 75% of the length of the portions of the first center conductor 6b and the second center conductor 7b, where these overlap the surface of the plate-shaped magnetic material 5.

In the intersection portion 35, by making the length of the overlapping portions of the two line conductors of the first center conductor 6b and the second center conductor 7b 10% or more of the length of the portion of the center conductors, which overlap the obverse surface (the other surface) of the plate-shaped magnetic substrate 5, the capacitance value, which is ensured in the overlapping portion of the first center conductor 6b and the second center conductor 7b, increases as the length of the overlapping portion increases. Thus, the inductance of the first center conductor 6b and the second center conductor 7b can be decreased correspondingly, that is, the conductor length of the center conductors 6b and 7b can be decreased, and this is advantageous for the size reduction of the nonreciprocal circuit element 1. Furthermore, by increasing the capacitance value ensured in the overlapping portion of the first center conductor 6b and the second center conductor 7b, the capacitance of the capacitance element 11 (to be described later) connected to the first center conductor 6b and the second center conductor 7b can also be decreased, thus contributing to the size reduction of the nonreciprocal circuit element 1.

Next, the magnetic assembly 15 is arranged in the center of the bottom part of the lower yoke 2b; in both side portions of the magnetic assembly 15 on the bottom side of the lower yoke 2b, matching capacitors 11 and 12, which are long and narrow in plan view, in the shape of a plate having a thickness of approximately half of that of the plate-shaped magnetic material 5, is housed; and in the lower yoke 2b, the termination resistor 13 is housed on one side of the matching capacitor 12.

Then, the front-end conductor 6c of the first line conductor 6 is electrically connected, by means such as soldering, to an electrode section 11a formed in the end portion on one side of the matching capacitor 11. The front-end conductor 7c of the second line conductor 7 is electrically connected, by means such as soldering, to an electrode section 11b formed in the end portion on the other side of the matching capacitor 11. The front-end conductor 8c of the third line conductor 8 is electrically connected, by means such as soldering, to the matching capacitor 12 and the termination resistor 13. In this manner, the matching capacitors 11 and 12 and the termination resistor 13 are connected to the magnetic assembly 15.

Furthermore, in the lower yoke 2b, in the end portion of the matching capacitor 11 to which the portion of the front-end conductor 7c is connected, a first port P1 of the nonreciprocal circuit element 1 is formed; in the end portion of the capacitor substrate 11 to which the front-end conductor 6c is connected, a second port P2 of the nonreciprocal circuit element 1 is formed; and in the end portion of the termination resistor 13 to which the front-end conductor 8c is connected, a third port P3 of the nonreciprocal circuit element 1 is formed.

Next, in the space section between the lower yoke 2b and the upper yoke 2a, the magnetic assembly 15 is formed to a thickness which occupies approximately half of the thickness of that space section. In the space section nearer the upper yoke 2a than the magnetic assembly 15, a spacer member 30 shown in FIG. 1B is housed, and the magnet member 4 is mounted on the spacer member 30.

The spacer member 30 consists of a substrate section 31 in the shape of a rectangular plate in plan view at a size at which it can be housed inside the upper yoke 2a, and leg sections 31a formed on the four corner portions of the bottom part of the substrate section 31. A circular housing recessed section 31b is formed on the surface (top surface) on the side on which the leg sections 31a . . . are not formed in the substrate section 31, and a rectangular transparent hole (not shown) which goes through the substrate section 31 is formed on the bottom side of the housing recessed section 31b.

Then, the magnet member 4 made of a disk-shaped permanent magnet is fitted into the housing recessed section 31b. The four leg sections 30a of the spacer member 30 provided with the magnet member 4 cause the matching capacitors 11 and 12, the front-end conductors 6c and 7c connected to the matching capacitors, the termination resistor 13, and the front-end portion of the front-end conductor 8c connected to the termination resistor 13 to be pressed against the bottom part of the lower yoke 2b. The bottom part of the spacer member 30 causes the magnetic assembly 15 to be pressed against the bottom part of the lower yoke 2b. In this state, the magnetic assembly 15 is housed between the yokes 2a and 2b.

In the nonreciprocal circuit element 1 of the configuration shown in FIGS. 1 to 3, the plate-shaped magnetic substrate 5, and the first, second, and third line conductors 6, 7, and 8 are housed in the hollow yoke body 3 whose outer shape is approximately a square of 3.5 mm or approximately a square of 3 mm, and both the first line conductor 6 and the second line conductor 7 are folded on the obverse surface of the plate-shaped magnetic substrate 5. Consequently, the signal, which is input from the line conductor on the input side to the plate-shaped magnetic substrate 5, can be effectively propagated to the output side, and thus low-loss and wide-band passing characteristics can be exhibited. Therefore, appropriate magnetic characteristics of the magnetic assembly 15 can be reliably obtained.

Furthermore, in a case where the nonreciprocal circuit element 1 of this embodiment is provided in a mobile phone used at a relatively low frequency, such as approximately 0.8 to 0.9 GHz, the inductance needs to be increased. In this embodiment, by forming the slit sections 18 and 19 in the line conductors 6 and 7, respectively, and by dividing each line conductor to two divided portions, mutual inductance is generated, so that, even in the case of the same length of the line conductor, a larger inductance can be obtained in the configuration in which the line conductor is divided. This makes it possible to decrease as much as possible the capacitance of the matching capacitor 12, and as a result, the size of the nonreciprocal circuit element 1 can be reduced more advantageously.

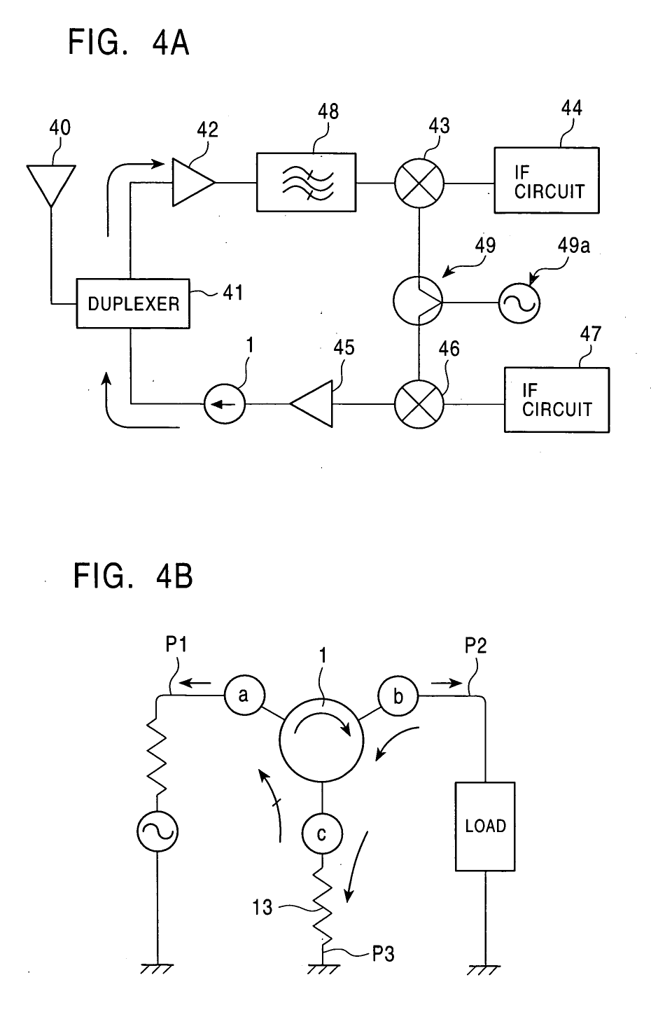

FIG. 4A shows an example of the circuit configuration of a mobile phone to which the nonreciprocal circuit element is applied. In this example, the circuit configuration is formed as follows. A duplexer 41 is connected to an antenna 40. An IF circuit 44 is connected to the output side of the duplexer 41 via a low-noise amplifier 42, an interstage filter 48, and a mixing circuit 43. An IF circuit 47 is connected to the input side of the duplexer 41 via a power amplifier 45 and a mixing circuit 46. A local oscillator 50 is connected to the mixing circuits 43 and 46 via a distribution transformer 49.

The nonreciprocal circuit element 1 of the above-described configuration is used by being incorporated in the circuit of a mobile phone shown in FIG. 4A. The nonreciprocal circuit element 1 operates so as to allow the signal from the nonreciprocal circuit element 1 to the duplexer 41 to be passed with low loss, but operates so as to shield the signal in the opposite direction by increasing the loss. This exhibits the function such that an unwanted signal, such as noise, on the amplifier 45 side is not reversely input to the amplifier 42.

FIG. 4B shows the operating principles of the nonreciprocal circuit element 1 of the above-described configuration. In the nonreciprocal circuit element 1 incorporated in the circuit shown in FIG. 4B, although the signal from the first port P1 side indicated by reference mark “a” to the second port P2 indicated by reference mark “b” is transmitted, the signal from the second port P2 indicated by reference mark “b” to the third port P3 indicated by reference mark “c” is attenuated by the termination resistor 13 and is absorbed, and the signal from the third port P3indicated by reference mark “c” on the termination resistor 13 side to the first port P1 indicated by reference mark “a” is shielded.

Therefore, when it is incorporated in the circuit shown in FIG. 4A, the above-described advantages can be obtained.

In the embodiments described in the foregoing, for the magnetic assembly 15, a combination of the magnetic substrate 5 in the form of a hexagonal shape shown in FIG. 2 and the electrode section 16 shown in FIG. 3 is used. Of course, for the magnetic assembly to be used in the present invention, a magnetic assembly formed of a disc-shaped magnetic substrate, three line conductors arranged so as to surround it, and a common electrode arranged on the reverse surface thereof may be used. In the magnetic assembly used in the present invention, the shape of the magnetic substrate to be used is not particularly limited, and also the shape of the line conductor is not particularly limited.

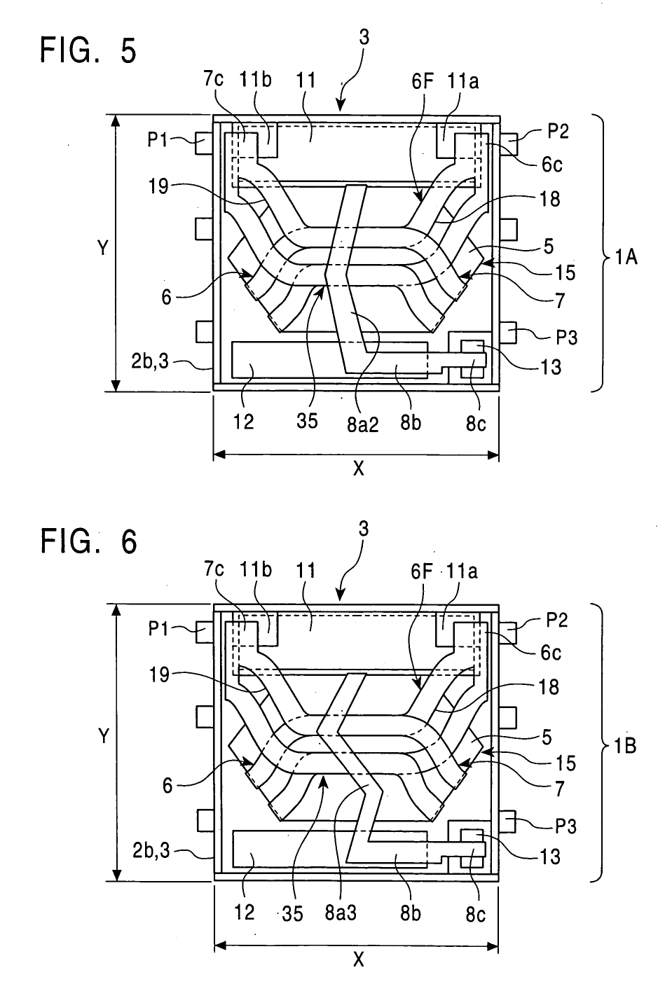

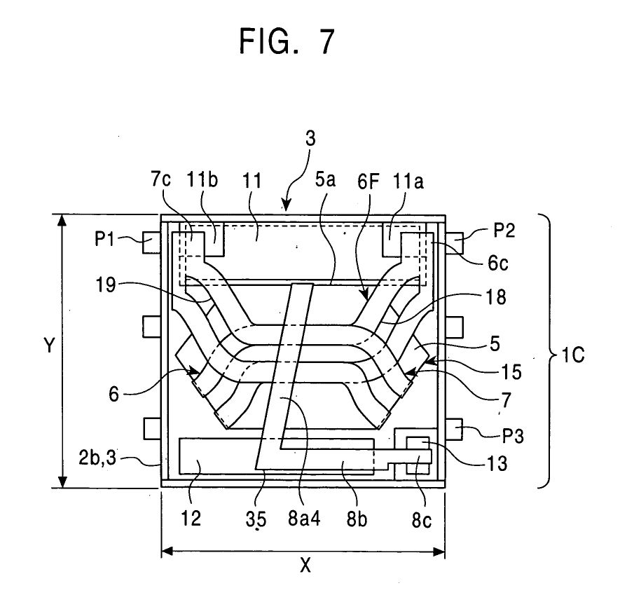

In the above-described first embodiment, the third line conductor 8 is shaped so as to extend in a straight-line manner on the main surface of the magnetic substrate 5. However, the shape of the third line conductor 8 is not limited to a straight line, and the third line conductor 8 may be formed in a bent shape like the symbol “<” as in a third line conductor 8a2 in a second embodiment shown in FIG. 5, a shape which is bent in a zigzag shape as in a third line conductor 8a3 in a third embodiment shown in FIG. 6, and a shape which extends in an inclined manner, that is, in a straight-line manner, with respect to the magnetic substrate 5 as in a third line conductor 8a4 in a fourth embodiment shown in FIG. 7.

In the third line conductor 8a4 which is inclined as shown in the fourth embodiment shown in FIG. 7, preferably, the extension direction thereof is at an inclination angle in the range of 90° to 120° with respect to a long side 5a of the magnetic substrate 5. In other words, the line segment connecting the ground side (the side on which the center conductor 8a4 is folded on the capacitor substrate 11 side) of the magnetic substrate 5 in the center conductor 8a4 of the line conductor 8 connected to the termination resistor 13 to the termination resistor 13 side is inclined in the range of 90° to 120° with respect to the line segment connecting the input side (port P1) of the other line conductors 6 and 7, excluding the line conductor 8, with the output side (port P2).

As described above, by making the center conductor 8a4 to be at an inclination angle in the range of 90° to 120° with respect to the long side 5a of the magnetic substrate 5, the inductance of the line conductor 8 can be increased to make the isolation satisfactory. The reason for this is considered that, in the nonreciprocal circuit element using a horizontally extended plate-shaped magnetic material (YIG), the characteristic impedance seen from the termination resistor side approaches 50 Ω, matching is improved, and the reflection is suppressed.

In the configuration of the nonreciprocal circuit element shown in FIG. 1, a nonreciprocal circuit element of a 3.2-mm square was assembled by using a magnetic substrate in a hexagonal shape in plan view shown in FIG. 2, having a composition Y₂Gd₁Fe_{4.58}In_{0.1}Al_{0.2}O₁₂. The detailed sizes of the magnetic substrate are such that the inclination angle with respect to the long-side section of the oblique-side section is 60°, the length of the longest side of one set is 1.6 mm, the width is 1.5 mm, and the thickness is 0.35 mm. The bias ferrite magnet used has a length of 2.4 mm, a diameter of 2.95 mm, and a thickness of 0.45 mm.

A plurality of magnetic substrates of this size were provided, and a plurality of magnetic assembly samples were produced by causing various line conductors to be wound around the magnetic substrates. In the magnetic assembly samples, the widths of the first line conductor, the second line conductor, and the third line conductor were set as shown in Table 1 and Table 2 below, the overlapping widths of the portions where the first line center conductor and the second center conductor overlap were set as shown in Table 1 and Table 2 below, and the capacitance (pF) of the capacitor connected to each port, the value (Ω) of the termination resistor connected to each port, loss (dB), and the value of isolation (dB) were set as shown in Table 1 and Table 2 below.

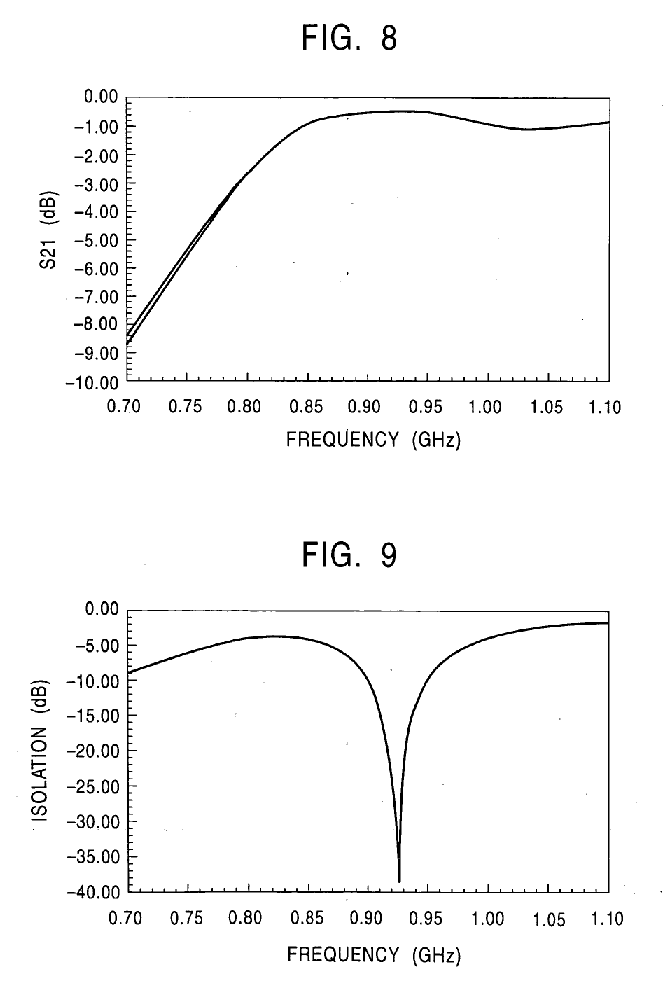

The results obtained by performing characteristic evaluation tests of the nonreciprocal circuit element having the above shape, shown in Table 1 and Table 2, are shown in FIGS. 8, 9, and 10. In Table 1 and Table 2, the port P1 represents the first port to which the first line conductor is connected, the port P2 represents the second port to which the second line conductor is connected, and the port P3 represents the third port to which the third line conductor and the termination resistor are connected.

TABLE 1

| | | | | Parallel | Size of | Size of | Capaci- | Capaci- | Capaci- | Resist- |
|---|---|---|---|---|---|---|---|---|---|---|
| | P1 | P2 | P3 | section | ferrite | magnetic | tance | tance | tance | ance |
| No. | (μm) | (μm) | (μm) | (μm) | magnet | substrate | (pF) | (pF) | (pF) | (Ω) |
| 1 | 300-100 | 300-100 | 250 | 0 | 4 × 3.2 × 0.450 t | Hexagon 30° 16 mm | 12.4 | 12.4 | 19.4 | 100 |
| 2 | 300-100 | 300-100 | 250 | 300 | 4 × 3.2 × 0.450 t | Hexagon 30° 16 mm | 12.7 | 12.7 | 19.3 | 100 |
| 3 | 300-100 | 300-100 | 250 | 500 | 4 × 3.2 × 0.450 t | Hexagon 30° 16 mm | 12.7 | 12.7 | 19.3 | 105 |
| 4 | 300-100 | 300-100 | 250 | 700 | 4 × 3.2 × 0.450 t | Hexagon 30° 16 mm | 12.4 | 12.4 | 19.4 | 100 |
| 5 | 300-100 | 300-100 | 250 | 900 | 4 × 3.2 × 0.450 t | Hexagon 30° 16 mm | 12.7 | 12.7 | 19.3 | 100 |
| 6 | 300-100 | 300-100 | 250 | 1100 | 4 × 3.2 × 0.450 t | Hexagon 30° 16 mm | 12.7 | 12.7 | 19.3 | 105 |
| 7 | 300-100 | 300-100 | 250 | 1300 | 4 × 3.2 × 0.450 t | Hexagon 30° 16 mm | 11.7 | 12.7 | 19.5 | 180 |

TABLE 2

| | | | | Parallel | Loss | Isolation |
|---|---|---|---|---|---|---|
| | L1(L2) | L3 | L1/ | section | (Minimum) | (Maximum) |
| No. | (mm) | (mm) | L3 | (μm) | (dB) | (dB) |
| 1 | 2.2 | 1.6 | 1.375 | 0 | 0.66 | 8.11 |
| 2 | 2.3 | 1.6 | 1.4375 | 300 | 0.66 | 8.19 |
| 3 | 2.4 | 1.6 | 1.5 | 500 | 0.66 | 8.03 |
| 4 | 2.5 | 1.6 | 1.5625 | 700 | 0.68 | 8.12 |
| 5 | 2.6 | 1.6 | 1.625 | 900 | 0.69 | 8.1 |
| 6 | 2.7 | 1.6 | 1.6875 | 1100 | 0.76 | 6.78 |
| 7 | 2.8 | 1.6 | 1.75 | 1300 | 0.95 | 5.23 |

In Table 1, the value 300-100 of the port P1 means that, in the center conductor configuration in which a slit is provided in the center conductor of the line conductor connected to the port P1, the total width of the center conductor including the slit was set to 300 μm and the slit width was set to 100 μm, and therefore, the individual widths of the conductor portions of the center conductor having two divided portions was set to 100 μm.

In Table 2, L1 indicates the length of the center conductor connected to the port P1, L3 indicates the length of the center conductor connected to the port P3, and the parallel section indicates the overlapping length (the length in the X direction of the nonreciprocal circuit element 1 in the overlapping portion shown in FIG. 1A) of the portion where the center conductor on the main surface of the magnetic substrate in the line conductor connected to the port P1 overlap the center conductor on the main surface of the magnetic substrate in the line conductor connected to the port P3.

In Table 2, the sample of the parallel section “0” indicates one in which the center conductor in the first line conductor connected to the port P1and the center conductor in the second line conductor connected to the port P2 are made to extend in a straight manner so as to intersect each other on the main surface of the magnetic substrate; and the parallel section “300 μm” indicates one in which the center conductor in the first line conductor connected to the port P1 and the center conductor in the second line conductor connected to the port P2 are partially bent on the main surface of the magnetic substrate so as to intersect each other in a layered manner at a width of 300 μm (the same state as that shown in FIG. 1A). In the following, 500 to 1300 μm of the parallel sections of the table indicate the overlapping intersection portion in the center conductor in each sample.

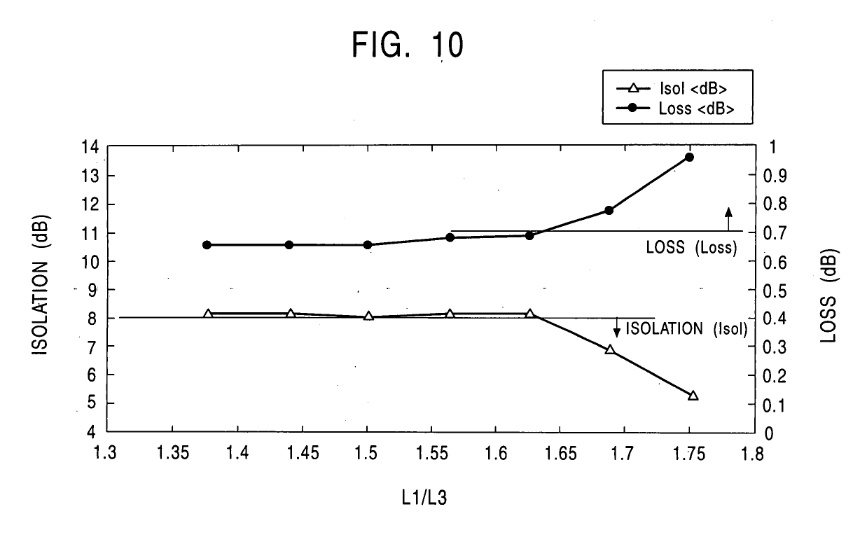

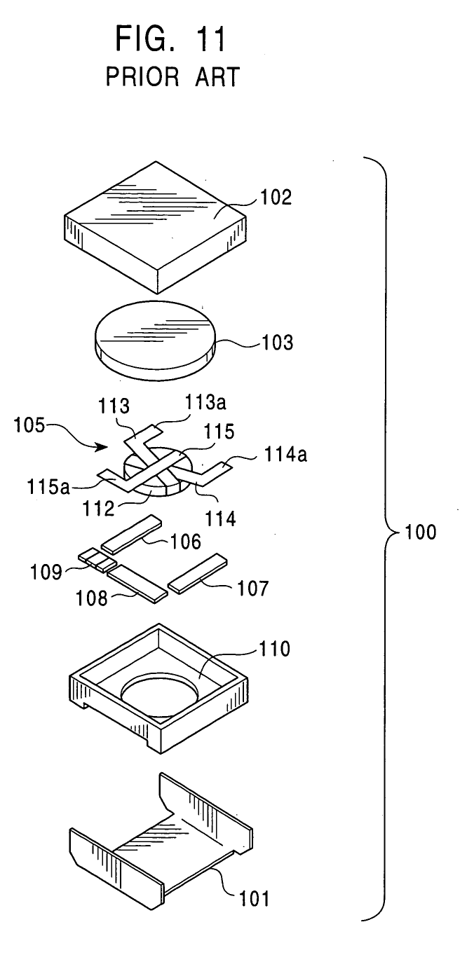

The samples Nos. 1 to 7 shown in Tables 1 and 2 are samples in which the intersecting overlapping portions are gradually changed from the above conditions in the center conductor on the main surface of the magnetic substrate. In each of the samples No. 1 to No. 7, as shown in FIGS. 8 and 9, the results of the measurements of the dependence of the value S₂₁ (S parameter: insertion loss) on frequency, which is known as the characteristic evaluation of the nonreciprocal circuit element, and the dependence of the isolation on frequency were obtained. Based on these measurement results, as shown in Table 2, the value of the isolation and the value of the loss (insertion loss) were determined, and furthermore, as shown in FIG. 10, the relationship between the isolation and L1/L3 was plotted.

The S parameter is a parameter used to evaluate electronic parts, such as nonreciprocal circuit elements, and, for example, the value of |S₂₁| is referred to as “insertion loss”. In an electronic part, an electronic part having two ports (input and output ports) P1 and P2 is assumed. The degree at which the wave entering from the port P1 of the electronic part is reflected toward the port P1of the part itself is S₁₁ (return loss), and the degree at which the wave is transmitted to the port P2 is S21 (insertion loss), in contrast, the degree at which the wave entering from the port P2 is reflected toward the port P2 of the part itself is S22 (return loss), and the degree at which the wave is transmitted from the port P2 to the port P1 is S₁₂ (isolation).

Based on the measurement results of the isolation and the loss, shown in Table 2, and the measurement results, which are collectively shown in FIG. 10, if the value of L1/L3 exceeds 1.6875 (approximately equal to 1.69), the insertion loss (loss) becomes large, which is undesirable. Furthermore, if the value of L1/L3 exceeds 1.625, the isolation becomes small. However, since the loss is small until the value of L1/L3 is up to 1.685, it is considered that it can be put into practical use. Therefore, the value of L1/L3 is preferably 1.6875 or less, and more preferably, it is 1.625 or less.

Furthermore, if the value of L1/L3 becomes less than 1.0, the vertical dimension of the magnetic substrate becomes large. When the space where the capacitor is arranged in the vertical direction of the magnetic substrate is considered, since the overall dimensions of the nonreciprocal circuit element become large, the value of L1/L3 needs to be 1.0 or more. Therefore, the value of L1/L3 is in the range of 1.0 to 1.6875, and more preferably, it is in the range of 1.0 to 1.625. In this relationship, since it is set that L1=L2, the relation of L1/L3 is equivalent to L2/L3. Furthermore, preferably, the parallel section in the area where the parallel sections L1 and L2 overlap each other is 900 μm or less.

Furthermore, as an approach for decreasing the dimensions of the plate-shaped magnetic material without changing the length of L3, it is considered to be preferable that the relation of L1/L3 is fixed, and by adjusting the dimensions of the plate-shaped magnetic material, in particular, the length in the-vertical direction, L3 is 5% or more.

1. A nonreciprocal circuit element comprising:
a yoke body;
a magnetic substrate;
a plurality of line conductors arranged on the main surface of the magnetic substrate;
a plurality of capacitance elements arranged around said magnetic substrate; and
a magnet member for applying a bias magnetic field to said magnetic substrate,
wherein said plurality of line conductors overlap each other on a main surface of said magnetic substrate and are insulated from each other and are connected to each other on an opposing surface of said magnetic substrate, end portions of said line conductors which overlap on the main surface of said magnetic substrate are connected correspondingly to said capacitance elements, a termination resistor is connected to one of said line conductors, and a width of the line conductor to which the termination resistor is connected is smaller than individual widths of a plurality of the other line conductors.

2. A nonreciprocal circuit element comprising:
a yoke body;
a magnetic substrate;
a plurality of line conductors arranged to be individually insulated, on a main surface of the magnetic substrate;
a plurality of capacitance elements arranged around said magnetic substrate; and
a magnet member for applying a bias magnetic field to said magnetic substrate,
wherein said plurality of line conductors overlap on the main surface of said magnetic substrate and are connected to each other on an opposing surface of said magnetic substrate, end portions of said line conductors, overlap on the main surface of said magnetic substrate and, are connected correspondingly to said capacitance elements, a termination resistor is connected to one of said line conductors, and at least a portion of a part positioned on said magnetic substrate is formed as one conductor in said line conductor to which the termination resistor is connected.

3. A nonreciprocal circuit element according to claim 1, wherein the line conductor to which the termination resistor is connected is formed as one conductor, and said other line conductors are formed as conductors having divided portions in which a slit is formed along a longitudinal direction thereof.

4. A nonreciprocal circuit element according to claim 1, wherein, among the plurality of line conductors arranged on said magnetic substrate, a length of the portion on the magnetic substrate, of the line conductor, which is formed as said one conductor, is shorter than lengths of the other line conductors on the magnetic substrate.

5. A nonreciprocal circuit element according to claim 1, wherein a matching capacitance of the capacitance element connected to said line conductor connected to said termination resistor is larger than the capacitance connected to the other line conductors.

6. A nonreciprocal circuit element according to claim 1, wherein a length of a portion where the line conductor connected to said termination resistor crosses the main surface of said magnetic substrate is longer by 5% or more than a straight-line width of the magnetic substrate along a direction of that portion.

7. A nonreciprocal circuit element according to claim 1, wherein, excluding one line conductor connected to said termination resistor, a line conductor on a input side and a line conductor on an output side are provided, and a line segment connecting the grounding side and the termination resistor side of said magnetic substrate in the line conductor connected to said termination resistor is inclined in the range of 90° to 120° with respect to a line segment connecting the input side and the output side of said other line conductors excluding the line conductor.
